(19) United States
(12) Patent Application Publication
(10) Pub. No.: US 2010/0292998 A1
(43) Pub. Date: Nov. 18, 2010

(54) SYSTEM AND METHOD FOR RECOMMENDING RECIPES

(75) Inventors: Maarten Peter Bodlaender, Eindhoven (NL); Arvid Randal Nicolaas, Eindhoven (NL); Olivier Schneider, Eindhoven (NL); Mariana Simons-Nikolova, Eindhoven (NL); Annelies Goris, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/294,496

(22) PCT Filed: Mar. 8, 2007
(86) PCT No.: PCT/IB07/50773

§ 371 Date: Sep. 25, 2008

(30) Foreign Application Priority Data
Mar. 28, 2006 (EP) 06111829.5

(51) Int. Cl. G06Q 30/00; G06Q 50/00

(52) U.S. Cl. 705/2; 705/26

(57) ABSTRACT

A system (10) for providing a recipe recommendation to a user is provided. The system (10) comprises storage means (15) for storing recipes with ingredients and a user profile with food consumption relevant information about the user. A processor (14) is coupled to the storage means (15) for generating the recipe recommendation by, based on the user profile, selecting one of the stored recipes. A user interface (13), coupled to the processor (14) provides the recipe recommendation to the user. The storage means (15) further comprises an ingredient replacements list with list entries. A list entry comprises an original ingredient of one of the stored recipes, and a corresponding alternative ingredient. The processor (14) is arranged for, based on the user profile, adapting the selected recipe by substituting an original ingredient of the selected recipe with the corresponding alternative ingredient and for providing the adapted recipe to the user interface (13).

The invention relates to a system for providing a recipe recommendation to a user, the system comprising storage means for storing recipes comprising ingredients and a user profile comprising food consumption relevant information about the user. The system also comprises a processor, coupled to the storage means for generating the recipe recommendation by, based on the user profile, selecting one of the stored recipes, and a user interface, coupled to the processor for providing the recipe recommendation to the user.

The invention further relates to a method for providing a recipe recommendation to a user.

The invention also relates to a computer program product.

Overweight and obesity are becoming increasing concerns in society. In reaction to these developments, people are becoming more interested in eating healthier food. Lots of people follow or try to follow dietary guidelines that prescribe which food items and meals a person should or should not eat in order to loose weight or to remain at a healthy weight. It is difficult for users to comply with the dietary guidelines, as it forces them to either abandon known, well-liked food or to consume disliked food. This decreases the user's motivation to strictly follow the dietary guidelines.

It is an object of the invention to provide a system, which is able to recommend food that is healthy and well-liked at the same time.

According to a first aspect of the invention, this object is achieved by providing a system as described in the opening paragraph, wherein the storage means further comprises an ingredient replacements list with list entries, a list entry comprising an original ingredient of one of the stored recipes, and a corresponding alternative ingredient, and wherein the processor is arranged for, based on the user profile, adapting the selected recipe by substituting an original ingredient of the selected recipe with the corresponding alternative ingredient and for providing the adapted recipe to the user interface.

Based on the food consumption relevant information in the user profile, the selected recipes are adapted to better suit the user's dietary goals, tastes or preferences. The food consumption relevant information may comprise general information like height, sex, age and weight of the user, and more specific information, like food preferences or food intake related health problems (e.g. diabetes). By substituting ingredients in standard recipes, the system is able to adapt the recommendations in accordance with the user's weight, health, diet and/or preferences. The system may, e.g., substitute harmful ingredients in well-liked recipes with healthier ones or may substitute disliked ingredients in healthy recipes with alternative well-liked ones. The system according to the invention does not force the user to abandon known, well-liked food or to consume disliked food, while still providing healthy recipes in line with the user's diet.

In an embodiment of the system according to the invention, the list entry further comprises ingredient specific information about the original ingredient and the alternative ingredient. The specific information of an ingredient may, for example, comprise the price of the ingredient or the extent to which the ingredient is liked by the user. When taking into account the ingredient specific information, the processor may substitute an original ingredient and obtain, for example, a cheaper or more liked recipe.

Preferably, the ingredient specific information comprises nutritional values of the original ingredient and the alternative ingredient. The nutritional values make it possible for the processor to adapt the selected recipe to a user's specific dietary restrictions, or to choose, for example, low-fat, low-carb (carbohydrates) or low salt alternative ingredients.

The ingredient specific information may also comprise an optimal amount of the alternative ingredient for substituting a standard amount of the original ingredient, the optimal amount of the alternative ingredient having a similar effect on the stored recipe as the standard amount of the original ingredient.

Equal amounts of original and alternative ingredients do not always have the same effect on the taste and appearance of a prepared recipe. By specifying the optimal amount of the alternative ingredient for substituting a standard amount of the original ingredient, the user is helped with preparing the recipe in such a way that in spite of the replacement of an original ingredient with an alternative one, the taste of the adjusted recipe is similar to the taste of the original recipe.

The recipe may further comprise a preparation method. The included preparation method prescribes how to combine the ingredients for obtaining the most tasty and/or healthy meal. The prescribed preparation method may influence the substitution of ingredients. The substitution of ingredients may also influence the prescribed preparation method.

Preferably, the user profile comprises dietary guidelines for the user. With such a system, the user does not have to worry about whether a certain recipe does comply with his or hers dietary guidelines. If a recipe is recommended by the system, the user may rely on the fact that it is in accordance with the dietary guidelines. The user does not have to make difficult decisions about whether certain recipes are in line with the diet, but can rely upon the recipes suggested by the system.

Additionally, the user profile may comprise food preferences of the user, making the system capable of recommending recipes that are not only wholesome, but also well liked. For example, when two alternatives are available for substituting an original ingredient, then the processor may select the one most preferred by the user.

These and other aspects of the invention are apparent from and will be elucidated with reference to the embodiments described hereinafter.

### BRIEF DESCRIPTION OF THE DRAWINGS

In the drawings:

FIG. 1 schematically shows a system according to the invention, and

FIG. 2 shows a block diagram of a method according to the invention.

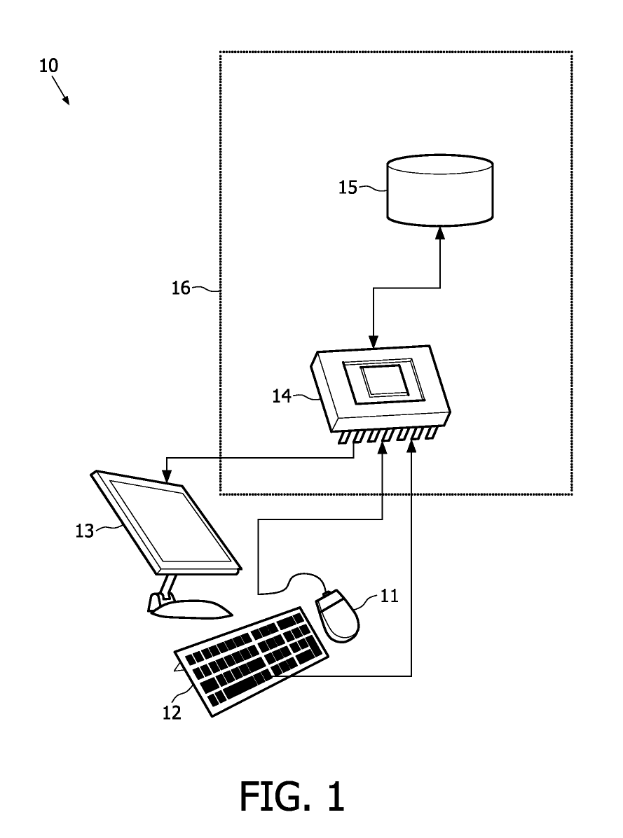

FIG. 1 schematically shows a system 10 according to the invention. The system 10 comprises a user interface with a keyboard 12, a mouse 11 or other type of pointer devices and a display 13 for enabling the user to provide information for the user profile or to control the recommender. The profile information comprises user specific details that are relevant for selecting which food to consume. The profile information may, e.g., comprise the user's length, weight, age, body fat percentage, food preferences, dietary guidelines, goal weight, caloric intake target, etc. Alternatively, the profile information may be provided using speech recognition or customer card or smartcard readers. Food preferences may, e.g., be obtained from a user's purchase history at a supermarket. Receipts may be scanned or the cash register may be linked to the system via, e.g., SMS, e-mail, Internet, infrared communication or Bluetooth. By registering when and how much a user buys of a particular type of food, the food preferences of this user may be obtained. Preferably, the results are corrected for, e.g., family size and age. User characteristics may also be obtained by analyzing entries in an electronic agenda. Parties that are planned in the evening may be taken into account when recommending a breakfast or lunch menu. User preferences may vary during the day. The user preferences may therefore comprise information about at what moments in the day a user likes a particular type of food.

The user display 13 of the user interface serves for presenting the recipe recommendation to the user. Alternatively, the recipe recommendation may be printed on paper, or provided as sound by speakers or headphones. The system 10 comprises storage means 15 for storing the profile information, recipes and information about the recipes. The storage means 15 may, e.g., be a hard disk, a solid-state memory, an optical disc. The user interface and the storage means 15 are coupled to a processor 14. The system 10 may be embodied as a PC with the storage means 15 and the processor 14 in one box 16, and the display 13, keyboard 12 and mouse 11 coupled thereto. The PC may be coupled to the Internet, for obtaining part of the user profile, recipes or ingredient replacement list. Alternatively, the user only has the user interface and an Internet connection and the recipe recommendation is generated at a remote server. The system 10 may also be embodied as a laptop computer or PDA. The processor 14 uses the profile information and the recipe information to recommend recipes to the user. Thereby, original ingredients of a recommended recipe are substituted with alternative ingredients, based on the user profile. For example, ingredients with much fat, carbohydrates, cholesterol or salt may be replaced by alternative ingredients with a similar effect on the flavor of the recipe, when the user profile indicates that such a substitution would benefit the health of the user. Substitution of ingredients may also serve to adapt the flavor of a healthy but originally disliked recipe.

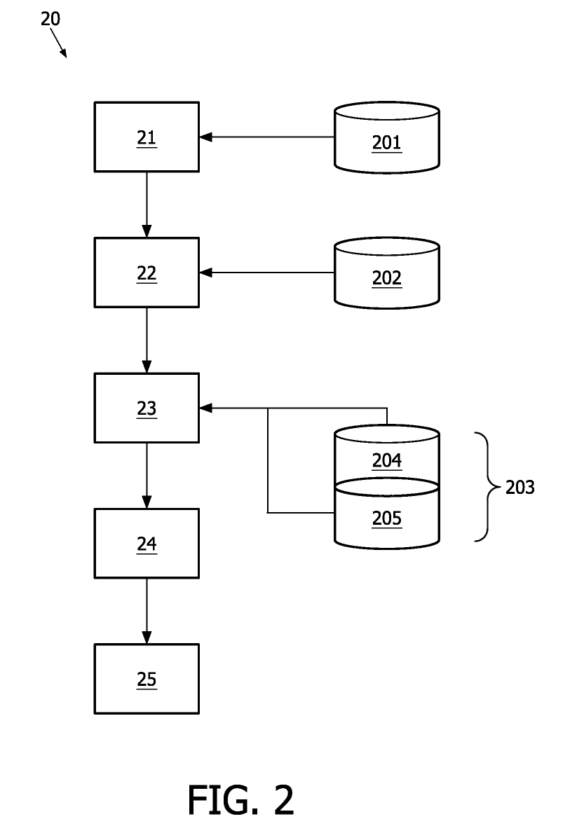

FIG. 2 shows a block diagram of a method 20 according to the invention. Such a method 20 may be performed by the system shown in FIG. 1. In a first profile obtaining step 21, the processor 14 obtains information about the user from the user profile 201. The information may comprise dietary restrictions, an overview of recently consumed meals, food preferences or other information, which is relevant for selection of a healthy and well-liked recipe.

Based on the profile information, in a second recipe obtaining step 22, one or more recipes are selected from a recipe database 202. The selection of recipes may also depend on other information than profile information only. For example, the selection of recipes may depend on weather, time of year or time of day.

In a third adjusting step 23, obtains list entries from an ingredient replacement list 203. The ingredient replacement list 203 comprises list entries with original ingredients 204 and corresponding alternative ingredients 205. Preferably, the ingredient replacement list also comprises additional information about the original 204 and the alternative ingredients 205. The additional information may comprise, for example, nutritional values, prices in different super markets or flavor effects. The additional information may also comprise information about the optimal amount of the alternative ingredient 205 for substituting a standard amount of the original ingredient 204. Preferably the prescribed amount of the alternative ingredient 205 has a similar effect on the selected recipe as the standard amount of the corresponding original ingredient 204. Two examples of parts of the ingredient replacement list 203 are shown in the following tables:

| Original | | | | | |
|---|---|---|---|---|---|
| Ingredient | Amount | | Replacement | Amount | |
| Penne Rigate | 150 | g | Gran D'Italia Whole grain penne | 150 | g |
| Sour cream | 100 | ml | Parmalat Low-fat Sour Cream | 100 | ml |
| Margarine | 20 | g | Becel Low-Fat Liquid Baking | 10 | ml |
| | | | butter | | |

| Product Alternatives | Amount | | Calories |
|---|---|---|---|
| Sugar | 1 | teaspoon | 46 |
| Natrena Sweetener liquid | 10 | ml | 15 |
| Sweet 'n Low powder sweetener | 30 | g | 11 |

| | | |
|---|---|---|
| . . . | . . . | . . . |

In the adapting step 24, the user information, recipe and list entries are combined to generate the final recipe recommendation. According to the profile information, some original ingredients of the recipe selected at the recipe obtaining step 22 are substituted by their corresponding alternative ingredients. The resulting recipe may, e.g., be healthier, more preferred by the user, less expensive or easier to prepare than the originally selected one.

Exemplary embodiments of a system according to the invention may show one or more of the following properties:

The followed diet determines which variants of food items the system should choose when a choice could be made. For example, the device chooses low-carb above low-fat products for a person following the Atkins diet.

The daily Caloric intake target determines the total amount of Calories that are available for a full meal. For example, the device chooses the lowest Calorie ingredient for a person following a Calorie restrictive diet.

The list of known recipes can be used as a starting point for tailoring recipes that adhere to the dietary restrictions and are liked and known by the user.

The preferred and disliked food categories are used to tailor recipes to, for example, vegetarian or vegan meals. For example, the device replaces chicken meat with vegetarian imitation meat (e.g. Valess), or with cashew nuts where appropriate.

Preferences regarding food preparation include information about preferred cooking time, preference for pre-packaged foods or fresh foods (e.g. is the user cleaning the fish himself?), level of cooking skills and availability of cooking equipment (e.g. does the user have the possibility to use an oven?).

Recipes also include preparation methods (cooking, steaming, baking, and frying). The included preparation method may affect both the taste and healthiness of food. The preparation methods prescribe how to combine the ingredients for obtaining the most tasty and/or healthy meal. For example, steaming of vegetables typically preserves taste and nutrients better than cooking The prescribed preparation method may influence the suggested ingredients and vice versa. For example, sugar replacement products like Natrema typically do not caramelize like sugar, therefore if significant heat is applied, they are not necessarily suitable. When the processor suggests substituting an original ingredient with the corresponding alternative ingredient, it may additionally suggest using a different preparation method.

The user's medical condition and medical concerns are used to determine if certain types of nutrients need to be restricted. For example, the device replaces food items containing salt with low-salt items for a person with high blood pressure.

The system uses product ratings from an online community to influence the decision. Replacement food that has a high rating will be chosen above lower rated food.

The system uses multiple user profiles to provide an alternative that is suitable for multiple users. For example, if a family contains one vegetarian person and one with high cholesterol, the recipes will be tailored to deliver meals that are both low-cholesterol and vegetarian.

The system uses price information of food items to choose the cheapest product when there is not much difference between the products. For example, if a cheap product has a similar result as an expensive product, the cheap product will be chosen.

Optionally, the device uses information about the availability of the products to choose a certain product. For example, if the user always goes shopping at the same supermarket, then it is unlikely that the user will buy an item that is not available at that supermarket.

Finally, in presentation step 25, the adapted recipe is provided to the user. The presentation may be realized by displaying the recommendation on the display screen 13, printing the recommendation on paper or by providing the recommendation as sound via speakers or headphones. Optionally, the device can print out the list of food items that the user should buy, to serve as a shopping list. The shopping list may alternatively be sent to a supermarket or other shop where the required ingredients are packed. The packed ingredients may then be delivered to the user or may be picked up by the user later. Optionally, the device shows a comparison between the original and optimized recipe, showing the original and replacement food items, and the total number of calories and other nutrient statistics. Optionally, the device estimates the total price for the recipe when the items are bought in the supermarket. As a result, the user can see whether the new recipe is within budget.

The system may provide more than one adapted recipe at a time. When presenting all recipes for the next few days, the user does not have to shop for the ingredients every day. Planning multiple recipes in advance further makes it possible to plan the total food intake of a user in conformity with a diet followed by the user. The system may provide an alert when a planned food intake moment is due or when a user should start preparing the recipe.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the system claim enumerating several means, several of these means may be embodied by one and the same item of hardware. The mere fact that certain measures are recited in mutually different dependent claims does not indicate that a combination of these measures cannot be used to advantage.

1. A system (10) for providing a recipe recommendation to a user, the system (10) comprising:
storage means (15) for storing recipes comprising ingredients and a user profile comprising food consumption relevant information about the user,
a processor (14), coupled to the storage means (15) for generating the recipe recommendation by, based on the user profile, selecting one of the stored recipes, and
a user interface (11, 12, 13), coupled to the processor (14) for providing the recipe recommendation to the user, wherein
the storage means (15) further comprises an ingredient replacements list with list entries, a list entry comprising:
an original ingredient of one of the stored recipes, and
a corresponding alternative ingredient, and wherein
the processor (14) is arranged for, based on the user profile, adapting the selected recipe by substituting an original ingredient of the selected recipe with the corresponding alternative ingredient and for providing the adapted recipe to the user interface (13).

2. A system (10) as claimed in claim 1, wherein the list entry further comprises ingredient specific information about the original ingredient and the alternative ingredient.

3. A system (10) as claimed in claim 2, wherein the ingredient specific information comprises nutritional values of the original ingredient and the alternative ingredient.

4. A system (10) as claimed in claim 2, wherein the ingredient specific information comprises an optimal amount of the alternative ingredient for substituting a standard amount of the original ingredient, the optimal amount of the alternative ingredient having a similar effect on the stored recipe as the standard amount of the original ingredient.

5. A system (10) as claimed in claim 1, wherein a recipe further comprises a preparation method.

6. A system (10) as claimed in claim 1, wherein the processor (14) is further arranged for providing a shopping list to the user interface (13), the shopping list comprising ingredients that are required for preparing the adapted recipe.

7. A system (10) as claimed in claim 1, wherein the user profile comprises dietary guidelines for the user.

8. A system (10) as claimed in claim 7, wherein the processor (14) is further arranged for planning multiple future food intake events in accordance with the dietary guidelines.

9. A system (10) as claimed in claim 8, wherein the processor (14) is further arranged for providing an alert message via the user interface (13) at a moment on which one of the planned future food intake event is planned.

10. A system (10) as claimed in claim 1, wherein the user profile comprises food preferences of the user.

11. A system (10) as claimed in claim 1, further comprising means for coupling the processor to Internet for receiving at least part of the recipes and/or user profile.

12. A method (20) for providing a recipe recommendation to a user, the method comprising the steps of:
based on a user profile (201) comprising food consumption relevant information about the user, selecting (22) a recipe from a plurality of recipes (202) comprising ingredients,
obtaining (23) at least one list entry from an ingredient replacements list (203), the list entry comprising:
an original ingredient (204) of the selected recipe, and
a corresponding alternative ingredient (205),
adapting (24) the selected recipe by substituting the original ingredient (204) with the corresponding alternative ingredient (205),
providing (25) the recipe recommendation by communicating the adapted recipe to the user.

13. A computer program product, which program is operative to cause a processor to perform a method as claimed in claim 12.
